(19) United States
(12) Patent Application Publication
(10) Pub. No.: US 2009/0289965 A1
(43) Pub. Date: Nov. 26, 2009

(54) LIQUID CRYSTAL DRIVING DEVICE

(75) Inventors: Yoshiki KUROKAWA, Tokyo (JP); Yukari KATAYAMA, Chigasaki (JP); Yasuyuki KUDO, Tokyo (JP); Akihito AKAI, Yokohama (JP); Hiroyuki NITTA, Fujisawa (JP); Kazuki HOMMA, Kodaira (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/467,648

(22) Filed: May 18, 2009

(30) Foreign Application Priority Data
May 21, 2008 (JP) 2008-132821

(51) Int. Cl. G09G 3/36; G09G 5/10

(52) U.S. Cl. 345/690; 345/101; 345/102

(57) ABSTRACT

A liquid crystal driving device is provided, which can reduce the problem of contrast lowering of the liquid crystal display screen due to the decrease of the driving current of LED, by the control which is performed in order to cope with the decrease of the maximum rated current of LED as a light source of the backlight at a high temperature. The liquid crystal driving device includes a liquid crystal driving circuit, a backlight control unit, and display data expansion circuits. The liquid crystal driving circuit generates a liquid crystal driving signal to be supplied to a liquid crystal display panel in response to display data. The backlight control unit reduces driving current of the light emitting diode as a light source of the backlight module to illuminate the liquid crystal display panel, in response to the temperature rise of the liquid crystal display panel. The display data expansion circuit, in response to the temperature rise of the liquid crystal display panel, performs the data expansion of the display data, and compensates the contrast lowering of the liquid crystal display panel due to the dimming of the backlight module with the temperature rise of the liquid crystal display panel.

### CLAIM OF PRIORITY

The present application claims priority from Japanese application JP 2008-132821 filed on May 21, 2008, the content of which is hereby incorporated by reference into this application.

### BACKGROUND OF THE INVENTION

The present invention relates to backlight control of a liquid crystal driving device, and in particular relates to technology which is useful to solve a problem of contrast lowering of a liquid crystal display screen due to decrease of a driving current of LED serving as a light source of the backlight at a high temperature.

In recent years, small and lightweight liquid crystal displays are mounted in information equipment, a mobile-phone, etc. which operate with a battery. These liquid crystal displays are mostly a transmissive type or a transflective type which requires a backlight.

A white LED is used for the backlight, since the white LED has low power consumption, a long life, and is easily reducible in size and weight. A white LED, which is produced commercially and used as a backlight of a mobile-phone mainly, has the most general structure of combination of a semiconductor light emitting diode (LED) which emits a blue light and fluorescent substance which emits a yellow light when a blue light is illuminated.

On the other hand, since the semiconductor LED has the property that it is easily destroyed when large current flows at a high temperature, the semiconductor LED has the temperature dependence that a maximum rated current value decreases at a high temperature. Therefore, when the operation guarantee range of the white LED as a backlight extends up to a high temperature such as 80° C., it is necessary to design the white LED so as not to violate the maximum rated current at the highest temperature in the operation guarantee range. For that reason, even if a white LED which can make flow the maximum rated current of 30 mA at a normal temperature is employed, the current at the normal temperature is preferably set to a small value of 10 mA, in order to set up an operating current value not to violate the maximum rated current at the highest temperature. Namely, since one piece of white LED can emits a reduced quantity of light when the operating current value at the normal temperature is set small, the white LEDs mounted in the backlight need to be increased in number, in order to obtain the desired brightness of the entire backlight.

On the other hand, in recent years, a large-sized liquid crystal panel for a television and other applications has tried to mount a white LED backlight, and some are already shipped as products. The quantity of emitted light of a white LED is very low, when compared with the other light source for backlights, such as a cold cathode fluorescent lamp (CCFL). Therefore, an issue at this time is that a large number of white LEDs need to be employed, leading to troublesome heat generation. As described above, since the maximum rated current of the white LED decreases at a high temperature due to heat generation, the reliability of a product becomes lower.

Patent Document 1 in the following discloses the technology to avoid the above issue, in which an output of a temperature detection circuit including a thermistor is supplied to a drive circuit, in order to decrease the driving current of LED at a high temperature, thereby coping with the decrease of the allowable forward current of LED at a high temperature (85° C.). By applying this temperature compensation technology to a backlight for a mid-size or small-size liquid crystal panel, the operating current value of LED at a normal temperature is made to approach the maximum rated current, while the operating current of LED is reduced at a high temperature. Accordingly, it is possible to reduce the number of LEDs mounted in the backlight.

Non-patent Document 1 in the following describes an automatic backlight brightness control function (Mobile AGCPS: Mobile Auto Gamma Control and Power Saving) which realizes low power consumption with display quality maintained. A driver IC recognizes the feature of inputted image data automatically and performs the dimmer control of a backlight brightness, responding to the inputted image data. When the inputted image data expresses a dark image, the backlight brightness is reduced to decrease the power consumption. When the backlight brightness alone is simply dimmed, the display screen becomes dark. Therefore, the display image of an LCD panel is compensated as much as the backlight is dimmed. Accordingly, the low power consumption is realized without deteriorating the display quality of the LCD panel. The image enhancement function which improves automatically the display quality of the LCD panel adjusts a γ-curve (gamma curve) automatically and makes the display screen of the LCD panel appear clearer, when the inputted image data to the driver IC is dark or has a low contrast.

Patent Document 2 in the following describes a color liquid crystal display device using a backlight with a LED as the light source, in which contrast control is applied to improve the contrast and to realize low power consumption. In the contrast enhancement, when the screen of a video signal is bright, the quantity of emitted light of the backlight device is increased; on the contrary, when the screen of the video signal is dark, the quantity of emitted light of the backlight device is decreased. In this way, the quantity of emitted light of the backlight device is increased or decreased in proportion to the brightness of the screen of the video signal. Three kinds of LEDs, a red LED, a green LED, and a blue LED, are used for the light source of a backlight device, and three kinds of lights, red, green, and blue, are mixed to generate a white light. This white light is emitted to the color liquid crystal display panel. The backlight device is provided with a temperature sensor which detects the temperature of LED of the light source, a chromaticity sensor which detects three kinds of quantity of lights or chromaticity, and a cooling fan. The detection value of the temperature sensor and the detection value of the chromaticity sensor are supplied to a backlight drive controller to control the driving current of LED as the light source. Responding to the detection value of the temperature sensor, the backlight drive controller controls the rotational speed of the cooling fan, and controls the temperature of LED as the light source of the backlight.

(Patent Document 1) Japanese Unexamined Patent Publication No. 2002-064223.

(Patent Document 2) Japanese Unexamined Patent Publication No. 2006-145886.

(Non-patent Document 1) Takashi Nose, et al., Semiconductor for Digital Consumer Field: “Development of LCD controller/driver ICs with an on-chip automatic backlight brightness control function (Mobile AGCPS)”, NEC TECHNICAL JOURNAL Vol. 60, No. 4/2007, PP. 14-17.

### SUMMARY OF THE INVENTION

In recent years, operating environment of the electronic information equipment of battery operation, such as a mobile-phone mounted with a liquid crystal display device, demands a wide range of operating temperature from a considerably low temperature to a considerably high temperature. Even for such a wide range of change of the operating temperature, it is required that the display quality of the liquid crystal display is maintained in the highest possible state.

The liquid crystal display device has begun to be adopted by display devices, such as a speedometer of the dashboard in front of a driver's seat of a vehicle, and a car-navigation system, in recent years. The dashboard in which the liquid crystal display device is mounted is located close to an engine room, and the operating environment of the dashboard demands a wide range of operating temperature from a considerably low temperature to a considerably high temperature. Even for a wide range of change of the operating temperature, it is required that the display quality is maintained in the highest possible state, since the liquid crystal display device mounted in the dashboard of the vehicle is related to safe driving.

The problem of decrease of the maximum rated current of LED as a light source of the backlight of a liquid crystal display at a high temperature as mentioned above can be solved by reducing the driving current of LED according to the output of the temperature detection circuit at a high temperature, as described in Patent Document 1. However, the problem of contrast lowering of the display screen of the liquid crystal display device due to the decrease of the driving current of LED as a light source of the backlight at a high temperature is difficult to solve with the technology described in Patent Document 1.

Although the technology described in Non-patent Document 1 also realizes low power consumption, maintaining the display quality, the technology can not solve the problem of contrast lowering of the display screen of the liquid crystal display device due to the decrease of the driving current of LED as a light source of the backlight at a high temperature. Although the contrast enhancement according to the technology described in Patent Document 2 realizes the improvement of contrast and the low power consumption, the present contrast enhancement can not solve the problem of contrast lowering of the liquid crystal display screen due to the decrease of the driving current of LED as a light source of the backlight at a high temperature. According to Patent Document 2, the backlight device is provided with a temperature sensor which detects the temperature of LED as a light source and a cooling fan, and the detection value of the temperature sensor controls the driving current of LED and the rotational speed of the cooling fan. However, the examination of the present inventors has clarified that it is difficult to solve the problem of contrast lowering of the liquid crystal display screen due to the decrease of the driving current of LED as a light source of the backlight at a high temperature, since the detection value of the temperature sensor is not used for the contrast enhancement.

The present invention is accomplished as a result of the examinations conducted by the present inventors in advance of the present invention.

Accordingly, the purpose of the present invention is to reduce the problem of contrast lowering of the liquid crystal display screen due to the decrease of the driving current of LED, by the control which is performed in order to cope with the decrease of the maximum rated current of LED as a light source of the backlight of a liquid crystal display panel at a high temperature.

The other purposes and the new feature of the present invention will become clear from the description of the present specification and the accompanying drawings.

The following is a brief explanation of typical one of the inventions disclosed in the present application.

That is, a typical liquid crystal driving device (101) according to the present invention includes a liquid crystal driving circuit (108), a backlight control unit (104, 205), and a display data expansion circuit (206, 207).

The liquid crystal driving circuit generates a liquid crystal driving signal (110) to be supplied to a liquid crystal display panel (114) in response to display data (209). The backlight control unit reduces driving current of the light emitting diode serving as a light source of the backlight module (115) to illuminate the liquid crystal display panel, in response to the temperature rise of the liquid crystal display panel. The display data expansion circuit, in response to the temperature rise of the liquid crystal display panel, performs the data expansion of the display data, and compensates the contrast lowering of the liquid crystal display panel due to the dimming of the backlight module in the temperature rise of the liquid crystal display panel (refer to FIG. 1 and FIG. 2).

The following explains briefly the effect acquired by the typical one of the inventions disclosed by the present application.

That is, the problem of contrast lowering of the liquid crystal display screen can be mitigated.

### BRIEF DESCRIPTION OF THE DRAWINGS

FIG. 1 is a drawing illustrating configuration of a liquid crystal driver according to one embodiment of the present invention;

FIG. 2 is a drawing illustrating configuration of a backlight temperature compensation control unit included in the liquid crystal driver according to the embodiment of the present invention illustrated in FIG. 1;

FIG. 3 (A) is a drawing illustrating an operating characteristic of a backlight current control circuit included in the backlight temperature compensation control unit according to the embodiment of the present invention illustrated in FIG. 2;

FIG. 3 (B) is a drawing illustrating configuration of the backlight current control circuit included in the backlight temperature compensation control unit according to the embodiment of the present invention illustrated in FIG. 2;

FIG. 4 is a drawing illustrating configuration of a display-data expansion coefficient calculating circuit and a display data multiplier which are included in the backlight temperature compensation control unit according to the embodiment of the present invention illustrated in FIG. 2;

FIG. 5 (A) is a drawing illustrating a situation of the expansion operation of display data performed by the display data multiplier illustrated in FIG. 4;

FIG. 5 (B) is a drawing illustrating another situation of the expansion operation of the display data performed by the display data multiplier illustrated in FIG. 4;

FIG. 6 is a drawing illustrating configuration of a liquid crystal driver and peripheral devices coupled to the liquid crystal driver, according to another embodiment of the present invention;

FIG. 7 is a drawing illustrating an example of configuration of a backlight control unit included in the liquid crystal driver illustrated in FIG. 6;

FIG. 8 is a drawing illustrating an operating characteristic of the backlight control unit according to the other embodiment of the present invention illustrated in FIG. 7;

FIG. 9 is a drawing illustrating configuration of a liquid crystal driver and peripheral devices coupled to the liquid crystal driver, according to yet another embodiment of the present invention; and

FIG. 10 is a drawing illustrating configuration of a temperature sensor output processing unit included in the backlight control unit of the liquid crystal driver according to yet another embodiment of the present invention illustrated in FIG. 9.

### DETAILED DESCRIPTION OF THE PREFERRED EMBODIMENTS

### Typical Embodiment

First, an outline is explained on a typical embodiment of the invention disclosed in the present application. A numerical symbol in parentheses referring to a component of the drawing in the outline explanation about the typical embodiment only illustrates what is included in the concept of the component to which the numerical symbol is attached.

(1) A liquid crystal driving device (101) according to a typical embodiment of the present invention includes a liquid crystal driving circuit (108), a backlight control unit (104, 205), and a display data expansion circuit (206, 207).

In response to display data (209), the liquid crystal driving circuit (108) generates a liquid crystal driving signal (110) to be supplied to a liquid crystal display panel (114).

The backlight control unit (104, 205) operates so as to decrease driving current of a light emitting diode as a light source of a backlight module (115) to illuminate the liquid crystal display panel, in response to a temperature rise of the liquid crystal display panel.

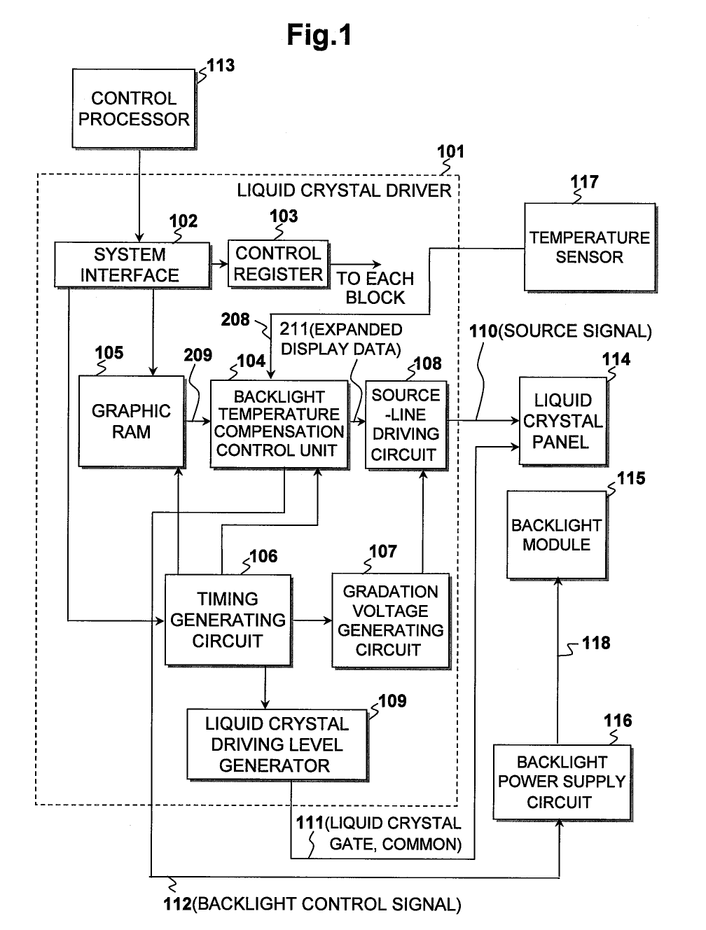

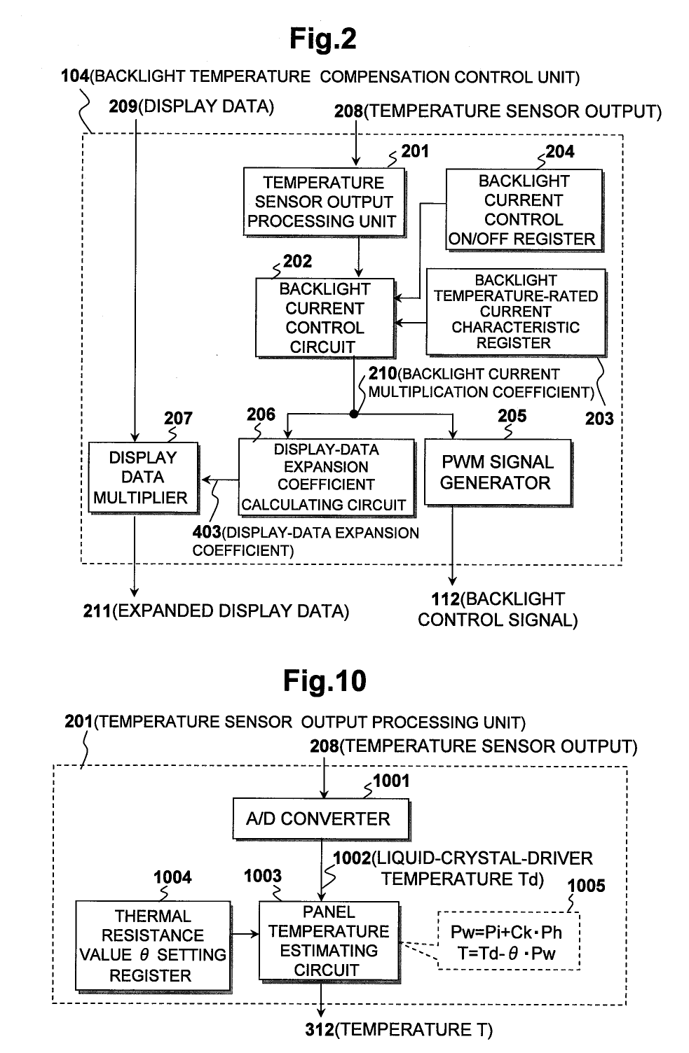

The display data expansion circuit (206, 207) performs data expansion of the display data to be supplied to the liquid crystal driving circuit in response to a temperature rise of the liquid crystal display panel. Accordingly, in case of a temperature rise of the liquid crystal display panel, contrast lowering of the liquid crystal display panel due to dimming of the backlight module is compensated (refer to FIG. 1 and FIG. 2).

According to the embodiment, it is possible to reduce the problem of contrast lowering of the liquid crystal display screen due to the control to decrease the driving current of LED, which is performed corresponding to the decrease of the maximum rated current at a high temperature of LED as a light source of the backlight of a liquid crystal display panel.

According to a preferred embodiment of the present invention, the backlight control unit (104) includes a temperature sensor processing unit (201) which generates temperature information on temperature of the liquid crystal display panel, and a backlight current control circuit (202) which calculates a current value of the driving current of the light emitting diode of the backlight module, in response to the temperature information generated by the temperature sensor processing unit (refer to FIG. 2).

According to a more preferred embodiment of the present invention, the backlight control unit (104) further includes a display-data expansion coefficient calculating circuit (206) which calculates a display-data expansion coefficient based on the current value calculated by the backlight current control circuit.

The display-data expansion coefficient calculated by the display-data expansion coefficient calculating circuit is supplied to the display data expansion circuit (207). The display data expansion circuit performs data expansion of the display data to be supplied to the liquid crystal driving circuit, in response to the display-data expansion coefficient (refer to FIG. 2).

According to another more preferred embodiment of the present invention, the backlight control unit further includes a register (203) which stores operation information used by the backlight current control circuit in calculating the current value of the driving current of the light emitting diode in response to the temperature information (refer to FIG. 2).

According to one specific embodiment of the present invention, the operation information can be set to the register externally via a system interface (102).

According to the most specific embodiment of the present invention, the operation information can be set to the register externally via the system interface, in a manner that the current value of the driving current of the light emitting diode calculated by the backlight current control circuit stays within a maximum rated current characteristic of the light emitting diode.

(2) A liquid crystal driving device (101) according to a typical embodiment of another viewpoint of the present invention includes a liquid crystal driving circuit (108), a backlight control unit (601), and a display data expansion circuit (206, 207).

In response to display data (209), the liquid crystal driving circuit (108) generates a liquid crystal driving signal (110) to be supplied to a liquid crystal display panel (114).

The backlight control unit (601) includes a first current control circuit (202) and a second current control circuit (701).

The display data expansion circuit (206, 207) performs data expansion of the display data to be supplied to the liquid crystal driving circuit.

The first current control circuit (202) of the backlight control unit (601) decreases driving current of a light emitting diode as a light source of a backlight module (115) to illuminate the liquid crystal display panel, in response to a temperature rise of the liquid crystal display panel. The display data expansion circuit performs the data expansion of the display data in response to control by the first current control circuit for the temperature rise, and compensates the contrast lowering of the liquid crystal display panel due to dimming of the backlight module induced by the temperature rise.

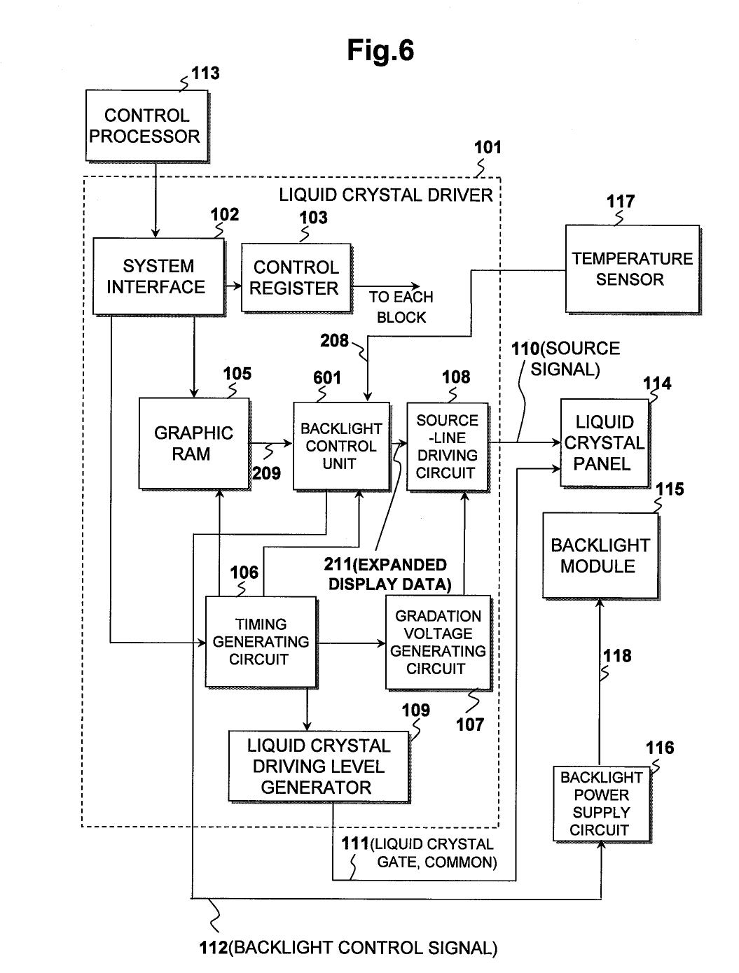

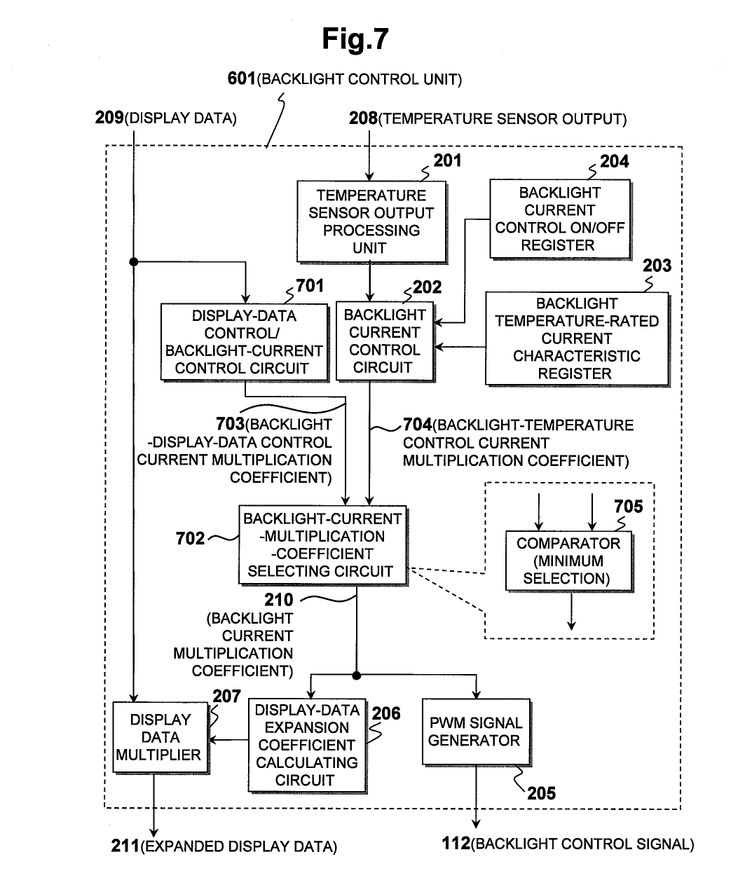

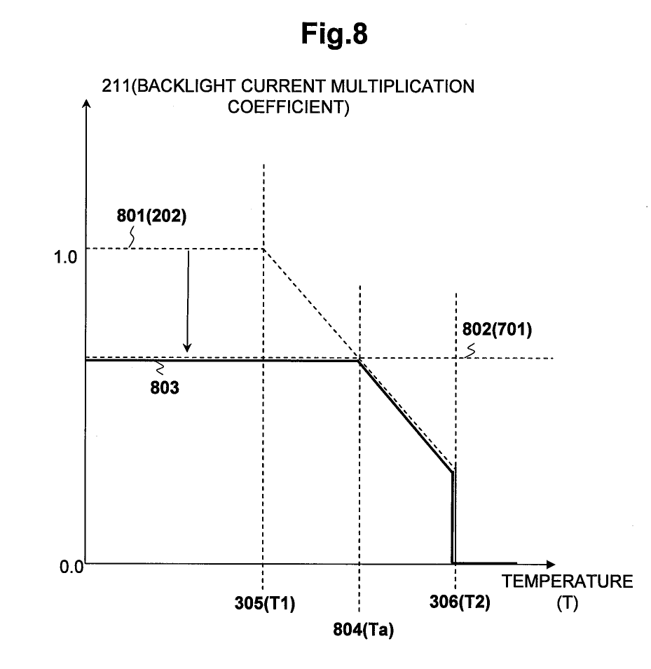

In response to a normal temperature of the liquid crystal display panel, the second current control circuit (701) included in the backlight control unit (601) controls, synchronously, the adjustment of the driving current of the light emitting diode of the backlight module and the degree of expansion in the data expansion of the display data performed by the display data expansion circuit, based on statistical information of a luminance value of the display data (209) (refer to FIG. 6, FIG. 7, and FIG. 8).

According to the embodiment of the other viewpoint, it is possible to reduce the problem of contrast lowering of the liquid crystal display screen due to the control to decrease the driving current of LED, which is performed in order to cope with the lowering of the maximum rated current of LED as a light source of the backlight of a liquid crystal display panel at a high temperature. When the liquid crystal display panel is at a normal temperature, the adjustment of the driving current of the light emitting diode of the backlight module and the degree of expansion of the data expansion of the display data performed by the display data expansion circuit are controlled synchronously, based on the statistical information of the luminance value of the display data. Therefore, it is possible to realize the liquid crystal display of a high display quality and with low power consumption.

According to a preferred embodiment, the backlight control unit (601) includes a temperature sensor processing unit (201) which generates temperature information on temperature of the liquid crystal display panel. Responding to the temperature information generated by the temperature sensor processing unit, the first current control circuit (202) calculates a current value of the driving current of the light emitting diode of the backlight module (refer to FIG. 7).

According to a more preferred embodiment, the backlight control unit (601) further includes a display-data expansion coefficient calculating circuit (206) which calculates a display-data expansion coefficient based on a current value of the driving current calculated by one of the first current control circuit and the second current control circuit.

The display-data expansion coefficient calculated by the display-data expansion coefficient calculating circuit is supplied to the display data expansion circuit (207). The display data expansion circuit performs data expansion of the display data to be supplied to the liquid crystal driving circuit, in response to the display-data expansion coefficient (refer to FIG. 7).

According to another more preferred embodiment, the backlight control unit includes a third current control circuit (702) to which a current value of the driving current calculated by the first current control circuit and a current value of the driving current calculated by the second current control circuit are supplied. The third current control circuit concerned selects a lower current value between the current value of the driving current calculated by the first current control circuit and the current value of the driving current calculated by the second current control circuit. Based on the lower current value selected by the third current control circuit, the current value of the driving current of the light emitting diode of the backlight module is set and the display-data expansion coefficient is calculated in the display-data expansion coefficient calculating circuit (206) (refer to FIG. 7).

According to yet another more preferred embodiment, the backlight control unit further includes a register (203) which stores operation information to be used by the first current control circuit in calculating the current value of the driving current of the light emitting diode in response to the temperature information (refer to FIG. 7).

According to one specific embodiment of the present invention, the operation information can be set to the register externally via a system interface (102).

According to the most specific embodiment of the present invention, the operation information can be set to the register externally via the system interface, in a manner that the current value of the driving current of the light emitting diode calculated by the first current control circuit stays within a maximum rated current characteristic of the light emitting diode.

According to another one specific embodiment, a semiconductor chip of the liquid crystal driving device (101) has a temperature sensor (901). The temperature sensor processing unit (201) generates the temperature information on the temperature of the liquid crystal display panel, based on the output of the temperature sensor (901), the power consumption (P_{W}) of the liquid crystal driving device (101), and the thermal resistance value (θ) of the liquid crystal driving device (101) (refer to FIG. 10).

According to another most specific embodiment, the backlight control unit (601) includes a register which stores a value of the power consumption, and a register which stores the thermal resistance value.

### Explanation of Embodiments

Next, embodiments are explained further in full detail. In the entire diagrams for explaining the embodiments of the present invention, the same symbol is attached to a component which has the same function, and the repeated explanation thereof is omitted.

<<Configuration of a Liquid Crystal Display Device>>

FIG. 1 illustrates configuration of a liquid crystal driver 101 according to one embodiment of the present invention. The liquid crystal driver 101 composes a liquid crystal display device with internal blocks 102-109 included therein and with peripheral devices 113-117 coupled thereto.

The liquid crystal driver 101 includes a system interface 102, a control register 103, a backlight temperature compensation control unit 104, a graphic RAM 105, a timing generating circuit 106, a gradation voltage generating circuit 107, a source-line driving circuit 108, and a liquid crystal driving level generator 109.

To the exterior of the liquid crystal driver 101, a control processor 113, a liquid crystal display panel 114, a backlight module 115 including LED for the backlight of the liquid crystal display panel 114, a backlight power supply circuit 116, and a temperature sensor 117 are coupled.

The liquid crystal driver 101 including the internal blocks 102-109 in this way is integrated on a silicon chip as a semiconductor integrated circuit (LSI: Large Scale Integrated circuit), and performs drive and control of the liquid crystal display panel 114.

As illustrated in FIG. 1, the system interface 102 of the liquid crystal driver 101 is coupled with the external control processor 113, and receives control data to the control register 103, display data to the graphic RAM 105, and a timing signal to the timing generating circuit 106 from the control processor 113.

First, the control processor 113 generates the display data, the control data, and the timing signal, and transfers them to the system interface 102 of the liquid crystal driver 101. The control data is transferred from the system interface 102 to the control register 103, the display data is transferred from the system interface 102 to the graphic RAM 105, and the timing signal is transferred from the system interface 102 to the timing generating circuit 106.

The display data transferred to the graphic RAM 105 is supplied to the source-line driving circuit 108 via the backlight temperature compensation control unit 104. Responding to the display data, the source-line driving circuit 108 generates a liquid crystal source driving signal 110 to be supplied to the liquid crystal display panel 114. Responding to the transferred timing signal, the timing generating circuit 106 generates an operation timing signal to be supplied to the backlight temperature compensation control unit 104, the gradation voltage generating circuit 107, and the liquid crystal driving level generator 109. Responding to the operation timing signal supplied from the timing generating circuit 106, the gradation voltage generating circuit 107 generates a gradation voltage and supplies it to the source-line driving circuit 108. Responding to the operation timing signal supplied from the timing generating circuit 106, the liquid crystal driving level generator 109 generates a liquid crystal gate driving signal/common driving signal 111 to be supplied to the liquid crystal display panel 114. Responding to the operation timing signal supplied from the timing generating circuit 106, the backlight temperature compensation control unit 104 generates a backlight control signal 112 to be supplied to the backlight power supply circuit 116. The control register 103 is a collective entity of control registers (register file) for controlling each part of the liquid crystal driver 101.

The liquid crystal display panel 114 is composed by a low temperature polysilicon TFT color LCD and is an active-matrix-type TFT (thin-film transistor) liquid crystal of a thin shape and a light weight, and with low power consumption. Since TFT is formed over a glass surface of the liquid crystal display panel 114 by deposition of a low temperature polysilicon, it is called an LTPS-TFT color LCD. LTPS stands for Low Temperature Poly-Silicon. In the active-matrix-type liquid crystal display panel 114, a TFT switching element, a storage capacitance, and a liquid crystal cell are arranged at the intersection of a signal electrode line (source line) and a scan electrode line (gate line). One ends of plural liquid crystal cells of the liquid crystal display panel 114 are coupled to drain electrodes of plural TFT switching elements, and the other ends of the plural liquid crystal cells are coupled to a common electrode. In order to prevent the polarization of the liquid crystal, the common driving signal 111 which reverses its polarity periodically is supplied from the liquid crystal driving level generator 109 to the common electrode. Plural signal electrode lines (source lines) of the liquid crystal display panel 114 in the horizontal direction are driven by plural liquid crystal source driving signals 110 of the source-line driving circuit 108. Plural scan electrode lines (gate lines) of the liquid crystal display panel 114 in the perpendicular direction are driven by the liquid crystal gate driving signal 111 of the liquid crystal driving level generator 109.

The backlight module 115 includes plural white LEDs arranged in a matrix as a light source of the backlight module 115 over the rear surface opposite to the screen surface of the liquid crystal display panel 114. A white LED which combines a blue-light emitting semiconductor LED and a yellow fluorescent substance is used as each of the plural white LEDs. According to the other embodiment of the present invention, a white LED in which the lights from three kinds of a red, a green and a blue LED are mixed to generate a white light can be used.

The backlight power supply circuit 116 supplies a driving power source voltage to plural white LEDs as a light source of the backlight module 115 via a backlight power line 118. The backlight power supply circuit 116 also controls the level of the driving power source voltage supplied to the plural white LEDs in response to the level of backlight control signal 112 generated by the backlight temperature compensation control unit 104. In this manner, as the light source of the backlight module 115, the plural white LEDs, to which the driving power source voltage is supplied via the backlight power line 118 from the backlight power supply circuit 116, emit a white light of desired brightness to the back surface of the liquid crystal display panel 114. With the backlight, the user can observe easily the display screen of the liquid crystal display panel 114 even in a dark environment.

The temperature sensor 117 is provided taking into consideration the possibility that the plural white LEDs as a light source of the backlight module 115 make large current at a high temperature. Accordingly, the temperature sensor 117 senses the temperature of the backlight module 115 or the temperature of the liquid crystal display panel 114, and supplies the sensed temperature information to the backlight temperature compensation control unit 104. This sensed temperature information may be expressed by an analog value or by a digitized numeric value.

<<A Backlight Temperature Compensation Control Unit>>

The backlight temperature compensation control unit 104, which is a block with a central function of the embodiment of the present invention, responds to the present temperature of the backlight module 115, or the present temperature of the liquid crystal display panel 114, based on the temperature information supplied by the temperature sensor 117.

That is, taking into consideration the possibility that the plural white LEDs as a light source of the backlight module 115 makes large current flow at a high temperature, the backlight temperature compensation control unit 104 generates a backlight control signal 112 in response to the sensed temperature information supplied by the temperature sensor 117. Due to a temperature rise, the operating current of the plural white LEDs of the backlight module 115 may increase and may exceed the maximum rated current in a certain case. The backlight power supply circuit 116 controls to decrease the level of the driving power source voltage supplied to the plural white LEDs of the backlight module 115, in response to the sensed temperature information from the temperature sensor 117 and the level of the backlight control signal 112 from the backlight temperature compensation control unit 104 at such a high temperature. As a result, possible destruction of the plural white LEDs of the backlight module 115 or deterioration of the reliability of the product at a high temperature can be avoided.

However, if the control is performed only for decreasing the level of the driving power source voltage supplied to the plural white LEDs of the backlight module 115 at a high temperature, there arises a problem in which the contrast (brightness) of the display screen of liquid crystal display panel 114 is decreased. In the embodiment of the present invention, in order to avoid this problem, the backlight temperature compensation control unit 104 responds to the sensed temperature information from the temperature sensor 117 at a high temperature, performs data expansion (contrast enhancement) with respect to the display data 209 from the graphic RAM 105, and supplies the expanded display data 211 after the data expansion to the source-line driving circuit 108. The source-line driving circuit 108 responds to the expanded display data after the data expansion supplied by the backlight temperature compensation control unit 104, selects a specific gradation voltage out of the gradation voltage prepared by the gradation voltage generating circuit 107, and supplies the selected gradation voltage to the plural signal electrode lines (source lines) of the liquid crystal display panel 114 as a liquid crystal source driving signal 110.

Therefore, the contrast lowering of the display screen of the liquid crystal display panel 114 due to the level lowering of the driving power source voltage supplied to the plural white LEDs of the backlight module 115 at a high temperature can be compensated by the data expansion of the display data performed by the backlight temperature compensation control unit 104.

<<Details of a Backlight Temperature Compensation Control Unit>>

FIG. 2 illustrates configuration of a backlight temperature compensation control unit 104 included in the liquid crystal driver 101 according to the embodiment of the present invention illustrated in FIG. 1.

The backlight temperature compensation control unit 104 illustrated in FIG. 2 includes a temperature sensor output processing unit 201, a backlight current control circuit 202, a backlight temperature-rated current characteristic register 203, a backlight current control on/off register 204, a PWM signal generator 205, a display-data expansion coefficient calculating circuit 206, and a display data multiplier 207.

The temperature sensor output processing unit 201 estimates the present temperature of the backlight module 115, or the present temperature of the liquid crystal display panel 114 from the temperature sensor output 208 supplied by the temperature sensor 117. That is, when the temperature sensor output 208 is given by an analog value, such as voltage, the temperature sensor output processing unit 201 converts the analog value into a digital value, by performing A/D conversion. When the temperature sensor output 208 is given by a digital value, the temperature sensor output processing unit 201 performs the subsequent data processing directly using the digital value. That is, the temperature sensor output processing unit 201 calculates a digital temperature value from the digital value of the temperature sensor output 208, and supplies the digital temperature value to the backlight current control circuit 202.

The backlight current control circuit 202 calculates a value of the drive current to flow through the plural white LEDs as the light source of the backlight module 115 at the present temperature, based on the digital temperature value from the temperature sensor output processing unit 201 and the register value stored in the backlight temperature-rated current characteristic register 203. When the digital temperature value from the temperature sensor output processing unit 201 is a large value, the value of the drive current to flow through the plural white LEDs as the light source of the backlight module 115 is controlled to a small value. The drive current value calculated is expressed by the ratio (multiplication coefficient) to the maximum rated driving current value. The ratio (multiplication coefficient) takes a value from 0 to 1.0, and is supplied to the PWM signal generator 205 and the display-data expansion coefficient calculating circuit 206 as a backlight current multiplication coefficient 210. Although the backlight current multiplication coefficient 210 is expressed by a value between 0 and 1.0, it may be alternatively expressed by an integer from 0 to 255, for example.

The backlight current control on/off register 204 performs activation (ON) and deactivation (OFF) of the above-described calculation function of the LED driving current, in response to the temperature by the backlight current control circuit 202. Accordingly, at the time of activation (ON), the above-described calculation of the LED driving current in response to the temperature is performed by the backlight current control circuit 202. At the time of deactivation (OFF), the calculation of the LED driving current is not performed regardless of the setting value of the backlight temperature-rated current characteristic register 203 and the temperature sensor output 208. Accordingly, at the time of the deactivation (OFF), the backlight current multiplication coefficient 210 from the backlight current control circuit 202 is maintained to a fixed value of 1.0. Consequently, at the time of the deactivation (OFF), the value of the backlight current multiplication coefficient 210 supplied to the PWM signal generator 205 and the display-data expansion coefficient calculating circuit 206 is maintained to the fixed value of 1.0, regardless of the value of the temperature sensor output 208.

The backlight temperature-rated current characteristic register 203 serves as a register for setting the temperature characteristic of the LED rated driving current for the backlight, and stores the plural temperature values and the plural corresponding values of the LED rated-driving current. The backlight temperature-rated current characteristic register 203 may be composed by a part of the collective entity of control registers (register file) of the control register 103. The register value stored in the control register 103 and the register value stored in the backlight temperature-rated current characteristic register 203 can be set by the control processor 113 via the system interface 102.

The backlight current control on/off register 204 can also be composed by a part of the collective entity of control registers (register file) of the control register 103. The register value stored in the backlight current control on/off register 204 can also be set by the control processor 113 via the system interface 102.

Responding to the backlight current multiplication coefficient 210 supplied by the backlight current control circuit 202, the PWM signal generator 205 generates a PWM (pulse width modulation) signal as a backlight control signal 112 for controlling the LED driving current value of the backlight module 115, and supplies it to the back light power 116. PWM stands for Pulse Width Modulation.

The display-data expansion coefficient calculating circuit 206 generates an expansion coefficient of the display data to be supplied to the display data multiplier 207, in response to the backlight current multiplication coefficient 210 supplied by the backlight current control circuit 202. When the value of the backlight current multiplication coefficient 210 from the backlight current control circuit 202 is small, the value of the expansion coefficient generated by the display-data expansion coefficient calculating circuit 206 becomes large.

Using the expansion coefficient of the display data supplied by the display-data expansion coefficient calculating circuit 206, the display data multiplier 207 performs data expansion operation of the display data 209 supplied by the graphic RAM 105, and supplies the expanded display data 211 as the result of the operation to the source-line driving circuit 108.

Accordingly, the backlight power supply circuit 116, to which the backlight control signal 112 is supplied after generated by the PWM signal generator 205 in response to the backlight current multiplication coefficient 210 at a high temperature, controls to decrease the level of the driving power source voltage supplied to the plural white LEDs of the backlight module 115. As a result, possible destruction of the plural white LEDs of the backlight module 115 or deterioration of the reliability of the product at a high temperature can be avoided. At the time of the high temperature, responding to the backlight current multiplication coefficient 210 and the value of the expansion coefficient generated by the display-data expansion coefficient calculating circuit 206, the contrast (luminance signal amplitude) of the expanded display data 211 generated by the data expansion operation of the display data multiplier 207 becomes large. As a result, the contrast lowering of the display screen of the liquid crystal display panel 114 due to the level lowering of the driving voltage supplied to the plural white LEDs of the backlight module 115 at a high temperature can be compensated by the data expansion of the display data in the display data multiplier 207 of the backlight temperature compensation control unit 104.

<<A Backlight Current Control Circuit>>

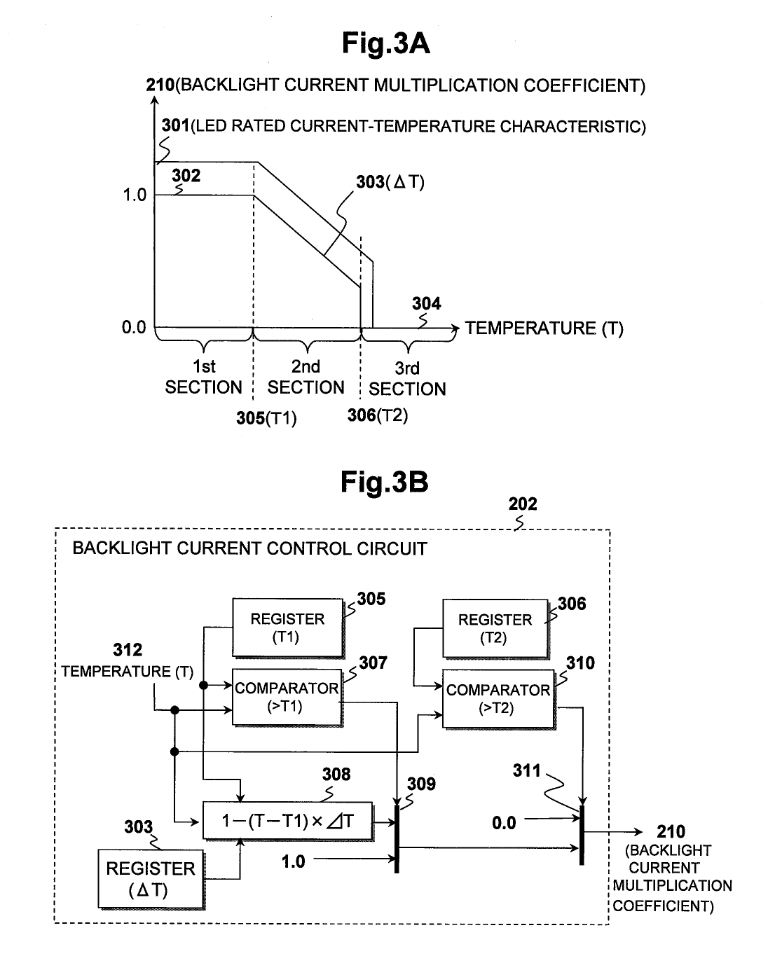

Next, FIG. 3 (A) illustrates an operating characteristic of the backlight current control circuit 202 included in the backlight temperature compensation control unit 104 according to the embodiment of the present invention illustrated in FIG. 2, and FIG. 3 (B) illustrates configuration of the backlight current control circuit 202 included in the backlight temperature compensation control unit 104 according to the embodiment of the present invention illustrated in FIG. 2.

That is, FIG. 3 (A) illustrates the temperature dependence of the backlight current multiplication coefficient 210 generated by the backlight current control circuit 202. In the figure, the horizontal axis T indicates the temperature of the backlight module 115 or the temperature of the liquid crystal display panel 114, and the vertical axis indicates the current multiplication coefficient 210 of the backlight.

FIG. 3 (A) also illustrates the temperature characteristic of the maximum rated current of the white LED as a light source of the backlight module 115 in terms of the characteristic 301. The maximum rated current of the white LED has a large rated current up to a certain temperature. When the temperature exceeds a first temperature threshold 305 (T1), the maximum rated current decreases linearly with the temperature. Above a second temperature threshold 306 (T2), the temperature exceeds the operation guarantee temperature of the white LED, and the maximum rated current becomes zero so that the white LED may not operate. The parameter of the backlight current multiplication coefficient 210 of the backlight current control circuit 202 to the temperature change is determined so that the backlight current multiplication coefficient 210 does not exceed the maximum rated current of the white LED indicated by the characteristic 301 of FIG. 3 (A), with some safety margin. Specifically, the determination area of the parameter of the backlight current multiplication coefficient 210 is divided into three sections.

That is, in the first section, as indicated by the characteristic 302, the value of the backlight current multiplication coefficient 210 is fixed to 1.0, so that the coefficient current near the maximum rated current of the white LED may flow.

In the second section, a proportionality coefficient ΔT of a characteristic 303 is set so that the value of the backlight current multiplication coefficient 210 decreases, corresponding to the linear decrease of the maximum rated current of the white LED. Accordingly, the value of the backlight current multiplication coefficient 210 can be reduced, in response to the temperature rise ΔT.

In the third section, it is determined that the temperature exceeds the operation guarantee temperature of the white LED, and the value of the backlight current multiplication coefficient 210 is fixed to zero, as indicated by a characteristic 304, so that the driving current of the white LED of the backlight becomes zero. With a suitable setup of the values of three parameters of (a) the first changeover temperature 305 (T1) from the first section to the second section, (b) the second changeover temperature 306 (T2) from the second section to the third section, and (c) the proportionality coefficient ΔT of the characteristic 303, it becomes possible to realize the temperature control of the driving current which is matched to the temperature dependence of the white LED used for the light source of the backlight module 115.

FIG. 3 (B) illustrates configuration of the backlight current control circuit 202 for realizing the temperature dependence of the backlight current multiplication coefficient 210 indicated by the characteristics 302, 303, and 304 of FIG. 3 (A).

The backlight current control circuit 202 illustrated in FIG. 3 (B) includes a proportionality coefficient register 303 (ΔT), a first temperature register 305 (T1), a second temperature register 306 (T2), a first comparator 307, a second-section backlight current multiplication coefficient calculating unit 308, a first selector 309, a second comparator 310, and a second selector 311.

A digital temperature value 312 supplied by the temperature sensor output processing unit 201 (T) is compared with the first changeover temperature T1 stored in the first temperature register 305 (T1) by the first comparator 307. When the condition T<T1 is satisfied, a high level “1” is generated from the output of the first comparator 307, and when the condition T<T1 is not satisfied, a low level “0” is generated.

The digital temperature value 312 (T) is also supplied to the second-section backlight current multiplication coefficient calculating unit 308, and the backlight current multiplication coefficient K2 in the second section is calculated by the following equation, using the value of the first changeover temperature T1 stored in the proportionality coefficient register 303 and the value of the proportionality coefficient ΔT stored in the first temperature register 305.

K2=1−(T−T1)×ΔT Eq. (1)

Responding to the high level “1” and the low level “0” of the output of the first comparator 307, the first selector 309 selects one of the fixed value 1.0 of the backlight current multiplication coefficient 210 to be used in the first section of FIG. 3 (A) and the backlight current multiplication coefficient K2 given by the output of the second-section backlight current multiplication coefficient calculating unit 308. That is, in response to the high level “1” of the output of the first comparator 307, the fixed value 1.0 of the backlight current multiplication coefficient 210 is selected by the first selector 309, and supplied to the second selector 311. Alternatively, in response to the low level “0” of the output of the first comparator 307, the backlight current multiplication coefficient K2 in the second section is selected from the first selector 309, and supplied to the second selector 311.

The digital temperature value 312 supplied by the temperature sensor output processing unit 201 (T) is compared with the second changeover temperature T2 stored in the second temperature register 306 (T2) by the second comparator 310. When the condition T<T2 is satisfied, a high level “1” is generated from the output of the second comparator 310, and when the condition T<T2 is not satisfied, a low level “0” is generated.

Responding to the high level “1” and the low level “0” of the output of the second comparator 310, the second selector 311 selects one of the output value from the first selector 309 and the fixed value 0.0 of the backlight current multiplication coefficient 210 to be used in the third section. Namely, responding to the high level “1” of the output of the second comparator 310, the second selector 311 selects the output value from the first selector 309, and outputs it as the backlight current multiplication coefficient 210. Responding to the low level “0” of the output of the second comparator 310, the second selector 311 selects the fixed value 0.0 of the backlight current multiplication coefficient 210 to be used in the third section, and outputs it as the backlight current multiplication coefficient 210.

<<A Display-Data Expansion Coefficient Calculating Circuit and a Display Data Multiplier>>

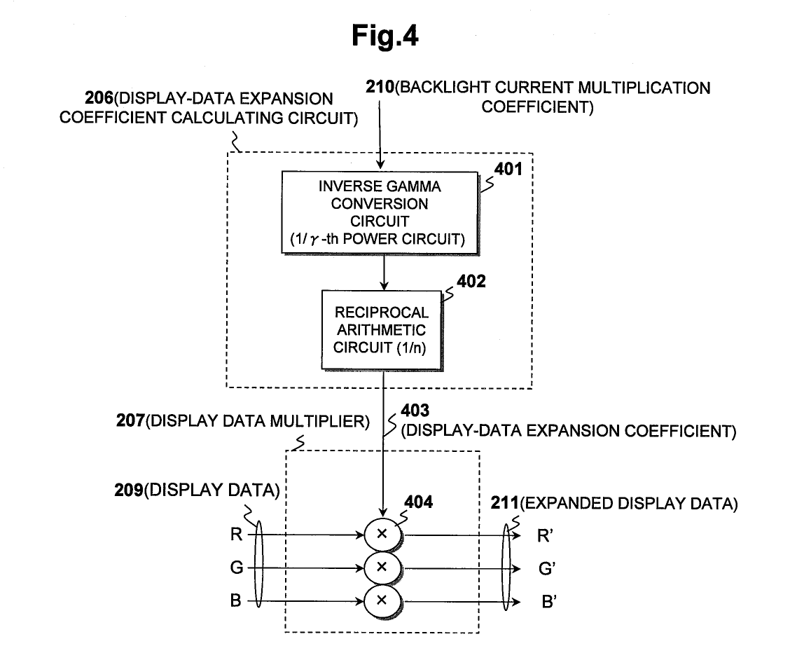

FIG. 4 illustrates configuration of a display-data expansion coefficient calculating circuit 206 and a display data multiplier 207 which are included in the backlight temperature compensation control unit 104 according to the embodiment of the present invention illustrated in FIG. 2.

The display-data expansion coefficient calculating circuit 206 illustrated in FIG. 4 includes an inverse gamma conversion circuit 401 and a reciprocal arithmetic circuit 402. The display data multiplier 207 illustrated in FIG. 4 includes three multipliers 404.

The inverse gamma conversion circuit 401 and the reciprocal arithmetic circuit 402 of the display-data expansion coefficient calculating circuit 206 illustrated in FIG. 4 perform a compensation operation, by responding to the backlight current multiplication coefficient 210 supplied by the backlight current control circuit 202. This compensation operation is performed by the data expansion of the display data, in order to compensate the contrast lowering of the display screen of the liquid crystal display panel 114 due to the level lowering of the driving voltage of the plural white LEDs of the backlight module 115 at a high temperature.

By using the backlight current multiplication coefficient 210, the inverse gamma conversion circuit 401 calculates the decreasing rate of the contrast (rate of brightness lowering) of a display of the liquid crystal display panel 114, which is induced by the decrease of the drive current value of the white LED, on the basis of the gradation value of the display data. At this time, since it is necessary to take into consideration the display gamma property of the liquid crystal display panel 114, the rate of brightness lowering is calculated by the inverse gamma operation of a gamma value of the display gamma property. As a result, since the rate of brightness lowering of the liquid crystal display panel 114 is calculated on the basis of the gradation value of the display data, it is possible for the reciprocal arithmetic circuit 402 to calculate the display-data expansion coefficient 403 which is necessary for the expansion calculation for compensating the brightness lowering. The display-data expansion coefficient 403 calculated by the reciprocal arithmetic circuit 402 is supplied to the display data multiplier 207.

Next, the display data multiplier 207 illustrated in FIG. 4 includes three multipliers 404. Each of three multipliers 404 performs multiplication of each data of three primary colors R, G, and B (which are subpixels of the display data 209 supplied by the graphic RAM 105) and the display-data expansion coefficient 403 supplied by the display-data expansion coefficient calculating circuit 206. As a result of the multiplication, the expanded display data 211 after the data expansion is generated by the display data multiplier 207 of the backlight temperature compensation control unit 104, in the form of compensated three primary colors R′, G′, and B′ which are compensated for the brightness lowering. The expanded display data 211 is supplied to the source-line driving circuit 108.

<<Display Data Expansion>>

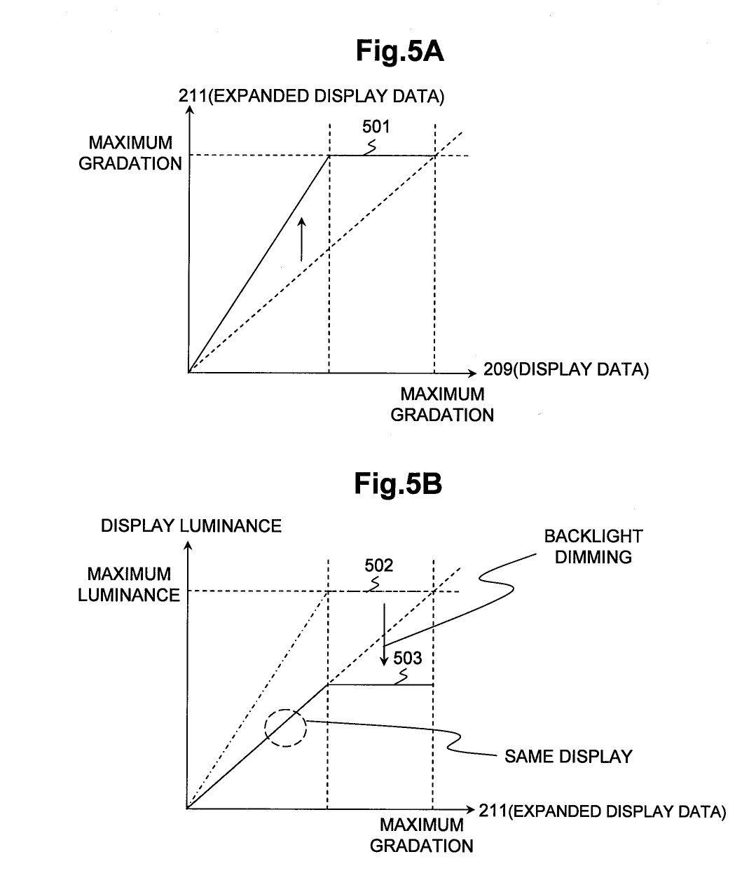

FIGS. 5 (A) and 5 (B) illustrate a situation of the expansion operation of the display data 209 performed by the display data multiplier 207 illustrated in FIG. 4.

FIG. 5 (A) illustrates the relationship between the display data 209 supplied from the graphic RAM 105 to the display data multiplier 207 and the expanded display data 211 generated by the expansion operation in the display data multiplier 207. In FIG. 5 (A), the horizontal axis indicates the gradation value of the display data 209 before the expansion, and the vertical axis indicates the gradation value of the expanded display data 211 after the expansion.

As indicated by the solid line 501 of FIG. 5 (A), with the display data multiplier 207 expanding the display data 209 supplied from the graphic RAM 105 by the multiplying factor of the display-data expansion coefficient 403 supplied from the display-data expansion coefficient calculating circuit 206, the value of the expanded display data 211 is increased in a range from low gradation to middle gradation. Accordingly, the display luminance of the liquid crystal display panel 114 can be raised. In a region of high gradation, the expansion result reaches the maximum gradation; therefore, the value of the expanded display data 211 is saturated at a maximum gradation value.

FIG. 5 (B) illustrates change of the display luminance of the liquid crystal display panel 114 due to the data expansion of the display data 209 performed by the display data multiplier 207. In FIG. 5 (B), the horizontal axis indicates the gradation value of the expanded display data 211 after the expansion, and the vertical axis indicates the display luminance of the liquid crystal display panel 114.

The dashed line 502 of FIG. 5 (B) illustrates the case where only the data expansion operation 501 of FIG. 5 by the display data multiplier 207 (A) is performed, without performing the dimming operation of the white LED of the light source of the backlight module 115 at a high temperature. In this case, in the range from the low gradation to the middle gradation, the display luminance of the liquid crystal display panel 114 increases, corresponding to the data expansion of the display data 209. As compared with this, the solid line 503 indicates the characteristic in the case where the dimming operation of the white LED of the light source of the backlight module 115 is also performed at a high temperature. As indicated by the solid line 503, in the range from the low gradation to the middle gradation, the increase in the display luminance of the liquid crystal display panel 114 due to the data expansion of the display data 209 can be cancelled by the dimming of the backlight module 115. Therefore, it can be understood that the characteristic in the range from the low gradation to the middle gradation indicated by the solid line 503 of FIG. 5 (B) realizes display luminance with the same characteristic as in the case where the dimming of the light source of the backlight module 115 at a high temperature is not performed and the data expansion of the display data 209 is not performed.

As described above, according to the embodiment of the present invention explained with reference to from FIG. 1 to FIG. 5, the following effects can be obtained. Namely, at a normal temperature, it is possible to use the drive current value of a high level which has been difficult to use because of the temperature characteristic of LED in which the maximum rated current has decreased, due to the decrease of the driving current of LED as the light source of the backlight module at a high temperature. As a result, it is possible to realize the high luminance of LED as the light source of the backlight module, and it is also possible to cut cost by reduction of the number of LEDs used for the light source of the backlight module. In the range from the low gradation to the middle gradation, it is possible to solve the problem that the liquid crystal panel display becomes low luminance due to the decrease of the driving current of LED as the light source of the backlight module at a high temperature, by performing the expansion of the display data, in phase with the drive current value of LED as the light source of the backlight module.

### Another Embodiment of the Present Invention

FIG. 6 illustrates configuration of a liquid crystal driver 101 and peripheral devices 113-117 coupled to the liquid crystal driver 101, according to another embodiment of the present invention.

The liquid crystal driver 101 illustrated in FIG. 6 is different from the liquid crystal driver 101 illustrated in FIG. 1 in the point that the backlight temperature compensation control unit 104 included in the liquid crystal driver 101 of FIG. 1 is replaced with a backlight control unit 601 in the liquid crystal driver 101 of FIG. 6.

First, the backlight control unit 601 of FIG. 6 performs data expansion with respect to the display data 209 supplied by the graphic RAM 105 and a first control for controlling the driving current of the white LED of the backlight module 115, in response to the display data 209 supplied by the graphic RAM 105. Furthermore, similarly to the backlight temperature compensation control unit 104 of FIG. 1, the backlight control unit 601 of FIG. 6 performs data expansion with respect to the display data 209 supplied by the graphic RAM 105 and a second control for controlling the driving current of the white LED of the backlight module 115, in response to the sensed temperature information supplied by the temperature sensor 117. In particular, the backlight control unit 601 of FIG. 6 performs one of the first control and the second control in preference to the other. By the priority execution of one of the first control and the second control, the driving current of the white LED of backlight module 115 is controlled to decrease more than in the case of the execution of the other; accordingly, it is possible to realize low power consumption.

FIG. 7 illustrates an example of configuration of a backlight control unit 601 included in the liquid crystal driver 101 illustrated in FIG. 6.

The configuration of the backlight control unit 601 illustrated in FIG. 7 has a display-data control/backlight-current control circuit 701 and a backlight-current-multiplication-coefficient selecting circuit 702 in addition to the components included in the backlight temperature compensation control unit 104 illustrated in FIG. 2.

The display-data control/backlight-current control circuit 701 illustrated in FIG. 7 obtains the statistical information of a luminance value about the display data of the entire display image from the display data 209 retrieved from the graphic RAM 105, and determines and outputs the backlight-display-data control current multiplication coefficient 703 based on the statistical information. A temperature sensor output processing unit 201, a backlight current control circuit 202, a backlight temperature-rated current characteristic register 203, and a backlight current control on/off register 204 of FIG. 7 are completely the same as the counterparts included in the backlight temperature compensation control unit 104 of FIG. 2.

In the backlight control unit 601 illustrated in FIG. 7, the backlight-current-multiplication-coefficient selecting circuit 702 selects either one of two current multiplication coefficients of the backlight-temperature control current multiplication coefficient 704 supplied by the backlight current control circuit 202 and the backlight-display-data control current multiplication coefficient 703 supplied by the display-data control/backlight-current control circuit 701, based on the priority rule. The backlight-current-multiplication-coefficient selecting circuit 702 outputs the selected one as backlight current multiplication coefficient 210. An example of the present priority rule selects the smaller value between two current multiplication coefficients.

That is, the backlight-current-multiplication-coefficient selecting circuit 702 of FIG. 7 includes a comparator 705, which determines the smaller value between two current multiplication coefficients 703 and 704, and selects and outputs the smaller value according to the determination result. Therefore, when the current multiplication coefficient 703 derived by the display data 209 supplied by the graphic RAM 105 is larger than the current multiplication coefficient 704 derived by the temperature sensor 117, the smaller current multiplication coefficient 704 derived by the temperature sensor 117 is selected. Accordingly, it is possible to reduce the driving current of LED of the backlight module 115 and to attain low power consumption. When the current multiplication coefficient 703 derived from the display data 209 is smaller than the current multiplication coefficient 704 derived from the temperature sensor 117, the backlight current multiplication coefficient 210 is decreased in response to the low brightness level of the display data 209, and the driving current of LED of the backlight module 115 is reduced; accordingly it is possible to attain low power consumption.

FIG. 8 illustrates an operating characteristic of a backlight control unit 601 according to the other embodiment of the present invention illustrated in FIG. 7.

That is, FIG. 8 illustrates the temperature dependence of the backlight current multiplication coefficient 210 which is generated by the backlight-current-multiplication-coefficient selecting circuit 702 of the backlight control unit 601 illustrated in FIG. 7. In FIG. 8, the horizontal axis indicates the temperature of the backlight module 115, or the temperature of the liquid crystal display panel 114, and the vertical axis indicates the backlight current multiplication coefficient 210.

In FIG. 8, the temperature dependence characteristic indicated by a dashed line 801 is dependent on the backlight-temperature control current multiplication coefficient 704 supplied by the backlight current control circuit 202 which responds to the temperature sensor 117 in FIG. 7, and corresponds to the characteristics 302 and 303 indicated in FIG. 3 (A). In FIG. 8, the temperature dependence characteristic indicated by a dashed line 802 is dependent on the backlight-display-data control current multiplication coefficient 703 supplied by the display-data control/backlight-current control circuit 701 which responds to the display data 209 supplied by the graphic RAM 105 in FIG. 7.

In FIG. 8, the temperature dependence characteristic indicated by a solid line 803 indicates the temperature dependence of the backlight current multiplication coefficient 210 generated by the backlight-current-multiplication-coefficient selecting circuit 702 which selects a smaller current multiplication coefficient in FIG. 7. In FIG. 8, at a temperature lower than the temperature 804 (Ta) of the intersection of the dashed line 801 and the dashed line 802, the value of the backlight current multiplication coefficient 210 is determined by the temperature dependence characteristic of the dashed line 802 which is dependent on the backlight-display-data control current multiplication coefficient 703 responding to the display data 209. In a temperature higher than the intersection temperature 804 (Ta), the value of backlight current multiplication coefficient 210 is determined by the temperature dependence characteristic of the dashed line 801 which is dependent on the backlight-temperature control current multiplication coefficient 704 responding to the temperature sensor 117.

As described above, according to the other embodiment of the present invention explained with reference to from FIG. 6 to FIG. 8, the following effects can be obtained.

Namely, at a temperature lower than the intersection temperature, the adjustment of the LED driving current of the backlight module 115 and the degree of expansion of the expanded display data 112 which determines the display luminance of the liquid crystal display panel 114 are controlled synchronously, based on the statistical information of the luminance value of the entire display image of the liquid crystal display panel 114. Accordingly, it becomes possible to realize the liquid crystal display of high display quality with low power consumption.

At a temperature higher than the intersection temperature or at a high temperature, it is possible to use the drive current value of a high level which has been difficult to use because of the temperature characteristic of LED in which the maximum rated current has decreased, due to the decrease of the driving current of LED of the backlight module 115 at a high temperature. As a result, it is possible to realize the high luminance of LED as the light source of the backlight module, and it is also possible to cut cost by reduction of the number of LEDs used for the light source of the backlight module. In the range from the low gradation to the middle gradation, it is possible to solve the problem that the liquid crystal panel display becomes low luminance due to the decrease of the driving current of LED as the light source of the backlight module at a high temperature, by performing the expansion of the display data, in phase with the drive current value of LED as the light source of the backlight module.

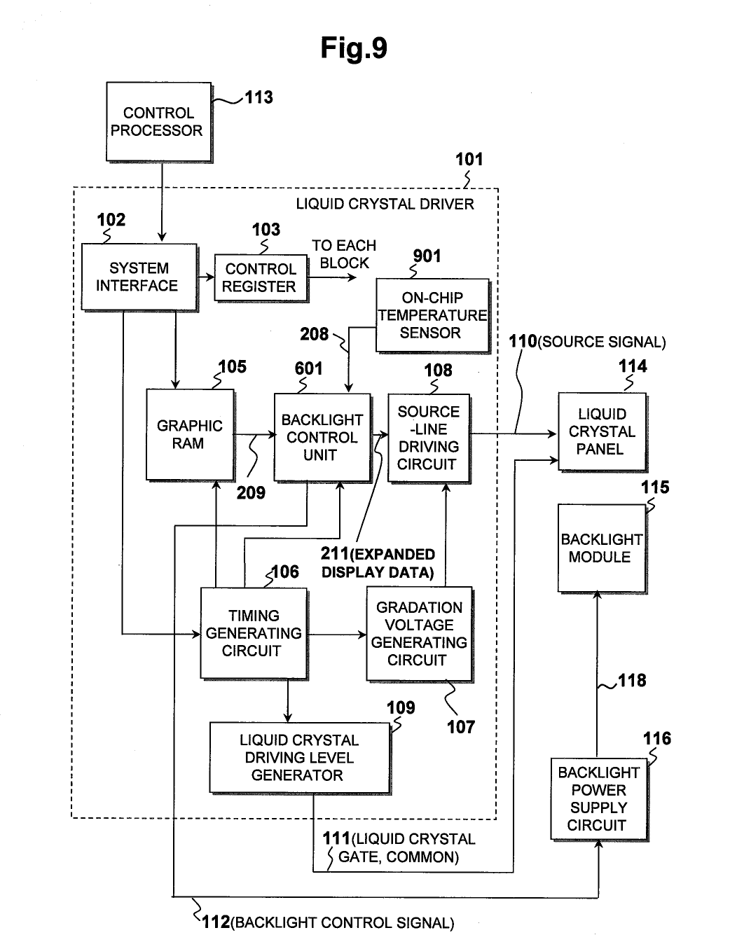

FIG. 9 illustrates configuration of a liquid crystal driver 101 and peripheral devices 113-117 coupled to the liquid crystal driver 101, according to yet another embodiment of the present invention.

The liquid crystal driver 101 illustrated in FIG. 9 is different from the liquid crystal driver 101 illustrated in FIG. 6 in the point that the temperature sensor 117 disposed outside the liquid crystal driver 101 of FIG. 6 is replaced with an on-chip temperature sensor 901 disposed inside the liquid crystal driver 101 of FIG. 9.

In the liquid crystal driver 101 illustrated in FIG. 9, the on-chip temperature sensor 901 is manufactured at the same time by the same semiconductor process as the other internal circuit blocks 102-103, 105-109, and 601, disposed inside the liquid crystal driver 101. Since the on-chip temperature sensor 901 is formed inside the liquid crystal driver 101, what is measured is not the temperature of the liquid crystal display panel 114, nor the temperature of the backlight module 115, but the temperature of the liquid crystal driver 101 adding the heat generation by operation of the liquid crystal driver 101.

The liquid crystal driver 101 is often implemented by a method in which the implementation heat dissipation is very poor, such that a chip of the liquid crystal driver 101 is mounted in COF (Chip On Film) etc. Therefore, although the liquid crystal driver 101 operates at a low speed as compared with other general logic LSIs, such as a baseband LSI and an application processor, the chip temperature becomes higher than the temperature of the liquid crystal display panel 114, or the temperature of the backlight module 115, and the difference cannot be disregarded. Accordingly, it is necessary to calculate the temperature of the liquid crystal display panel 114 or the temperature of the backlight module 115, by adding correction to the sense temperature of the on-chip temperature sensor 901 formed in the liquid crystal driver 101. In the liquid crystal driver 101 illustrated in FIG. 9, the compensation addition to the sense temperature of the on-chip temperature sensor 901 can be performed by the temperature sensor output processing unit 201 included in the backlight control unit 601 (the temperature sensor output processing unit 201 is illustrated in FIG. 7).

FIG. 10 illustrates configuration of the temperature sensor output processing unit 201 included in the backlight control unit 601 of the liquid crystal driver 101, according to yet another embodiment of the present invention illustrated in FIG. 9.

In FIG. 10, an analog output voltage 208 from the on-chip temperature sensor 901 of the liquid crystal driver 101 illustrated in FIG. 9 is converted into a liquid-crystal-driver digital temperature Td by an A/D converter 1001. The liquid-crystal-driver digital temperature Td from the A/D converter 1001 is supplied to one input terminal of a panel temperature estimating circuit 1003. On the other hand, a value corresponding to a thermal resistance value θ set at a register 1004 is supplied to the other input terminal of the panel temperature estimating circuit 1003. This thermal resistance value θ is a thermal resistance value between the liquid crystal driver 101 on the side of high temperature and the liquid crystal display panel 114 or the backlight module 115 on the side of low temperature.

On the other hand, the power consumption Pw of the liquid crystal driver of the liquid crystal driver 101 is given by the following equation.

Pw=Pi+(Ck×Ph) Eq. (2)

Here, Pi is a power consumption by the standby leakage current, etc. of the liquid crystal driver 101, Ck is a coefficient related to the frequency of the operation clock of the liquid crystal driver 101, and Ph is a power consumption of a digital circuit and an analog circuit which operate at an operation clock inside the liquid crystal driver 101. Ordinarily, the operation clock of the liquid crystal driver 101 is a display dot clock which serves as a clock of inputted image data.

Namely, the second term of the power consumption Pw given by Equation (2) expresses the power consumption which increases in proportion to the frequency of the operation clock. The value of the power consumption Pw given by Equation (2) is stored in a register (not shown) arranged inside the panel temperature estimating circuit 1003. The panel temperature estimating circuit 1003 calculates the temperature T of the liquid crystal display panel 114 or of the backlight module 115 as follows, by using the power consumption Pw of the liquid crystal driver obtained in the above, the liquid-crystal-driver digital temperature Td supplied from the A/D converter 1001, and the thermal resistance value θ set in the register 1004.

T=Td−(θ×P_{w}) Eq. (3)

In this way, the part of power consumption Pw of the liquid crystal driver 101 can be cancelled, even if the liquid-crystal-driver digital temperature Td supplied from the on-chip temperature sensor 901 through the A/D converter 1001 rises, due to a considerable amount of heat generation of the liquid crystal driver 101 by the power consumption Pw of the liquid crystal driver 101 given by Equation (2). As a result, the information on the exact temperature T of the liquid crystal display panel 114 or the backlight module 115 can be obtained from the panel temperature estimating circuit 1003.

In the above, the invention accomplished by the present inventors has been specifically explained based on the embodiments. However, it cannot be overemphasized that the present invention is not restricted to the embodiments, and it can be changed variously in the range which does not deviate from the gist.

For example, the liquid crystal driver can be applied not only to a mobile-phone but to a battery-operated small media player, such as a DVD player, mounted with a liquid crystal display.

What is claimed is:

1. A liquid crystal driving device comprising:
a liquid crystal driving circuit;
a backlight control unit; and
a display data expansion circuit,
wherein the liquid crystal driving circuit generates a liquid crystal driving signal to be supplied to a liquid crystal display panel in response to display data,
wherein the backlight control unit operates so as to decrease driving current of a light emitting diode as a light source of a backlight module to illuminate the liquid crystal display panel, in response to a temperature rise of the liquid crystal display panel, and
wherein the display data expansion circuit performs data expansion of the display data to be supplied to the liquid crystal driving circuit in response to a temperature rise of the liquid crystal display panel and compensates contrast lowering of the liquid crystal display panel due to dimming of the backlight module in case of a temperature rise of the liquid crystal display panel.

2. The liquid crystal driving device according to claim 1,
wherein the backlight control unit includes:
a temperature sensor processing unit operable to generate temperature information on temperature of the liquid crystal display panel; and
a backlight current control circuit operable to calculate a current value of the driving current of the light emitting diode of the backlight module, in response to the temperature information generated by the temperature sensor processing unit.

3. The liquid crystal driving device according to claim 2,
wherein the backlight control unit further includes:
a display-data expansion coefficient calculating circuit operable to calculate a display-data expansion coefficient based on the current value calculated by the backlight current control circuit,
wherein the display-data expansion coefficient calculated by the display-data expansion coefficient calculating circuit is supplied to the display data expansion circuit, and
wherein the display data expansion circuit performs data expansion of the display data to be supplied to the liquid crystal driving circuit, in response to the display-data expansion coefficient.

4. The liquid crystal driving device according to claim 3,
wherein the backlight control unit further includes:
a register operable to store operation information which is used by the backlight current control circuit in calculating the current value of the driving current of the light emitting diode in response to the temperature information.

5. The liquid crystal driving device according to claim 4,
wherein the operation information to be stored in the register is settable externally via a system interface.

6. The liquid crystal driving device according to claim 5,
wherein the operation information to be stored in the register is settable externally via the system interface, in a manner that the current value of the driving current of the light emitting diode calculated by the backlight current control circuit stays within a maximum rated current characteristic of the light emitting diode.

7. A liquid crystal driving device comprising:
a liquid crystal driving circuit;
a backlight control unit; and
a display data expansion circuit,
wherein the liquid crystal driving circuit generates a liquid crystal driving signal to be supplied to a liquid crystal display panel in response to display data,
wherein the backlight control unit includes:
a first current control circuit; and
a second current control circuit,
wherein the display data expansion circuit performs data expansion of the display data to be supplied to the liquid crystal driving circuit,
wherein the first current control circuit included in the backlight control unit decreases driving current of a light emitting diode as a light source of a backlight module to illuminate the liquid crystal display panel, in response to a temperature rise of the liquid crystal display panel,
wherein the display data expansion circuit performs the data expansion of the display data in response to control by the first current control circuit for the temperature rise, and compensates the contrast lowering of the liquid crystal display panel due to dimming of the backlight module induced by the temperature rise, and
wherein, in response to a normal temperature of the liquid crystal display panel, the second current control circuit included in the backlight control unit controls, synchronously, adjustment of the driving current of the light emitting diode of the backlight module and degree of expansion in the data expansion of the display data performed by the display data expansion circuit, based on statistical information of a luminance value of the display data.

8. The liquid crystal driving device according to claim 7,
wherein the backlight control unit includes:
a temperature sensor processing unit operable to generate temperature information on temperature of the liquid crystal display panel, and
wherein the first current control circuit calculates a current value of the driving current of the light emitting diode of the backlight module, in response to the temperature information generated by the temperature sensor processing unit.

9. The liquid crystal driving device according to claim 8,
wherein the backlight control unit further includes:
a display-data expansion coefficient calculating circuit operable to calculate a display-data expansion coefficient based on a current value of the driving current calculated by one of the first current control circuit and the second current control circuit, and
wherein the display-data expansion coefficient calculated by the display-data expansion coefficient calculating circuit is supplied to the display data expansion circuit, and the display data expansion circuit performs data expansion of the display data to be supplied to the liquid crystal driving circuit, in response to the display-data expansion coefficient.

10. The liquid crystal driving device according to claim 9,
wherein the backlight control unit includes:
a third current control circuit operable to be supplied with a current value of the driving current calculated by the first current control circuit and a current value of the driving current calculated by the second current control circuit, the third current control circuit being further operable to select a lower current value between the current value of the driving current calculated by the first current control circuit and the current value of the driving current calculated by the second current control circuit, and
wherein, based on the lower current value selected by the third current control circuit, the current value of the driving current of the light emitting diode of the backlight module is set and the display-data expansion coefficient in the display-data expansion coefficient calculating circuit is calculated.

11. The liquid crystal driving device according to claim 10,
wherein the backlight control unit further includes:
a register operable to store operation information to be used by the first current control circuit in calculating the current value of the driving current of the light emitting diode in response to the temperature information.

12. The liquid crystal driving device according to claim 11,
wherein the operation information to be stored in the register is settable externally via a system interface.

13. The liquid crystal driving device according to claim 12,
wherein the operation information to be stored in the register is settable externally via the system interface, in a manner that the current value of the driving current of the light emitting diode calculated by the first current control circuit stays within a maximum rated current characteristic of the light emitting diode.

14. The liquid crystal driving device according to claim 8,
wherein a semiconductor chip of the liquid crystal driving device includes a temperature sensor, and
wherein the temperature sensor processing unit generates the temperature information on the temperature of the liquid crystal display panel, based on an output of the temperature sensor, power consumption of the liquid crystal driving device, and a thermal resistance value of the liquid crystal driving device.

15. The liquid crystal driving device according to claim 14,
wherein the backlight control unit includes:
a register operable to store a value of the power consumption; and
a register operable to store the thermal resistance value.
